(19) United States
(12) Patent Application Publication
(10) Pub. No.: US 2009/0052720 A1
(43) Pub. Date: Feb. 26, 2009

(54) EARPHONE CONNECTION CABLE AND PORTABLE DEVICE PROVIDED WITH THE SAME

(75) Inventors: Daisuke Nishi, Ishikawa (JP); Kenya Nagano, Ishikawa (JP); Masanori Oshimi, Tokyo (JP); Masahiro Iwakami, Kanagawa (JP); Yousuke Matuda, Tokyo (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/279,150

(22) PCT Filed: Feb. 14, 2007
(86) PCT No.: PCT/JP2007/052648

§ 371 Date: Sep. 15, 2008

(30) Foreign Application Priority Data
Feb. 14, 2006 (JP) 2006-036312

(51) Int. Cl. H04R 25/00

(52) U.S. Cl. 381/384

(57) ABSTRACT

An earphone connection cable and a portable device for suppressing sound signal superposing between an R earphone and an L earphone or between an earphone and a microphone are provided. A connection cable includes an R earphone 116a and an L earphone 116b at tips and contains an antenna element 115, a ground potential line 114, an R sound signal line 108a, an L sound signal line 108b, an inductance 111, and a second inductance group, and the ground potential line of the R earphone 116a and the L earphone 116b is connected to the antenna element 115, thereby suppressing sound signal superposing between the R earphone and the L earphone.

### TECHNICAL FIELD

This invention relates to a linear conductor (earphone cable) having an antenna function and a sound signal transmission function and an electronic machine, a portable device provided with the earphone cable, such as a mobile telephone terminal, a media player with a communication function, or a gaming machine installing a communication function and in particular to higher performance of sound signal transmission.

### BACKGROUND ART

Hitherto, some of sound signal transmission cables (earphone cables) connected to electronic machines, portable devices such as a mobile telephone terminal, a media player with a communication function, and a gaming machine installing a communication function have been formed integrally with an antenna (for example, refer to patent document 1). In such a portable device, an earphone wire attached to the machine main body is also used as an antenna; for example, only one of left and right two earphone wires provided for outputting stereo sound is used as an antenna or both earphone wires are joined through a choke coil, etc., and the whole of the left and right two earphone wires is used as an antenna.

Left and right sound producing earphones (loudspeakers) are generally grounded as shown in FIGS. 5A and 5B or FIG. 6.

For example, in a portable device shown in FIG. 5A, a cable connector 506 is connected as it is inserted into a machine connector 505 of a portable device 501 including a tuner section 502 and a sound circuit 503. A plurality of electrically conductive terminal springs 504 are disposed in the machine connector 505, and the tuner section 502, the sound circuit 503, and electronic circuitry of a control section, etc., and cable signal lines not shown in the figure are electrically connected through the terminal springs 504.

The cable signal lines are made up of an R sound signal line 508a and an L sound signal line 508b connected to the sound circuit 503, an antenna signal line (reception wave transmission line) 509 connected to the tuner section, and a ground potential line 510. The antenna signal line 509 and the ground potential line 510 are connected to a coaxial line 507 and are joined and fixed to a relay unit 513 by soldering, etc., together with the R sound signal line 508a and the L sound signal line 508b.

In the relay unit 513, a plurality of inductance elements 512 are disposed and the R sound signal line 508a and the L sound signal line 508b are connected via the inductance element group 512 to an R earphone 516a and an L earphone 516b. When an R sound signal transmitted through the R sound signal line 508a from the machine arrives at the R earphone 516a, it turns back and is grounded to a ground potential line 514 through an R earphone ground line 514a and a contact S52. When an L sound signal transmitted through the L sound signal line 508b from the machine arrives at the L earphone 516b, it turns back and is grounded to the ground potential line 514 through an L earphone ground line 514b and the contact S52 like the R sound signal. The signal grounded to the ground potential line 514 is grounded to ground in the portable device through the inductance elements 512, (outer sheath of) the coaxial line 507, and the ground potential line 510.

On the other hand, an antenna signal (also called “reception wave;” hereinafter, ditto) transmitted through the antenna signal line 509 to the tuner section 502 arrives through the coaxial line 507 from the relay unit 513 and further propagates from antenna elements 515a and 515b branched along the R and L earphone cables with a contact S51 as a branch point through an antenna element 515. The tips of the antenna elements 515a and 515b are both open and are connected to neither the R earphone 516a nor the L earphone 516b.

Next, in a portable device shown in FIG. 6, when an R sound signal transmitted through an R sound signal line 608a from the machine arrives at an R earphone 616a through an inductance element 612 and a contact S63, it turns back and is grounded through an R earphone ground line 601 and a contact S62. On the other hand, an L sound signal transmitted through an L sound signal line 608b from the machine arrives at an L earphone 616b through an inductance element 612 and a contact S65, turns back, and is grounded through an L earphone ground line 602 and a contact S64.

That is, the ground composition of the portable device shown in FIG. 6, unlike that in FIGS. 5A and 5B, the R earphone ground line and the L earphone ground line are connected to different contacts and are grounded to separate ground potentials.

Patent document 1: Japanese Patent Laid-Open No. 2002-314450

### DISCLOSURE OF THE INVENTION

### Problems to be Solved by the Invention

However, the portable devices in the related arts shown in FIGS. 5 and 6 involve the following problems:

To begin with, if the ground contacts of R and L earphones are made common as in the portable device shown in FIGS. 5A and 5B, a problem of superposing of a sound signal of the L earphone on the R earphone or superposing of a sound signal of the R earphone on the L earphone occurs. The mechanism of occurrence of the problem is roughly as follows:

In FIG. 5B, enlargement of FIG. 5A between the relay unit 513 and the R earphone 516a and the L earphone 516b, the R earphone 516a and the L earphone 516b share the ground line in the contact S52 and thus an inductance element 512a disposed on the shared ground line is shared. In so doing, for example, if a sound signal is transmitted only to the R earphone 516a from the machine, a potential difference occurring when a return signal of the signal transmitted to the R earphone 516a passes through the inductance element 512a through the R earphone ground line 514a and the contact S52 (potential difference occurring between both ends V51 and V52 of the inductance element 512a) also affects the L earphone 516b to which no sound signal should be transmitted from the machine, and the R sound signal is transmitted.

Taking a specific use scene as an example, when the user views bilingual (Japanese and English) broadcast as a movie, news, etc., if the machine is controlled so as to output Japanese speech from the R earphone 516a and output English speech from the L earphone 516b, the English speech is mixed into the R earphone 516a or the Japanese speech is mixed into the L earphone 516b because of the superposing phenomenon described above in the earphone, so that the user becomes hard to listen to the languages; this is a problem. Alternatively, when a game is played, if the machine is controlled so as to output sound only from the R earphone as a special effect, the superposing phenomenon described above causes a defective condition of poor representation. Likewise, if control is performed so as to sway (allow) the effect sound (to flow) from the R side to the L side, a sufficient effect cannot be provided because of the superposing phenomenon; this is a problem.

The problems are not limited to the stereo earphone including the R and L earphones and in a portable device including a microphone and an earphone, a defective condition caused by sharing a ground line by the microphone and the earphone can also occur. For example, it is a problem of mixing of noise into the earphone by turning on/off the microphone. The principle is similar to that of the superposing phenomenon described above in the stereo earphone.

Next, in the portable device shown in FIG. 6, the R earphone 616a and the L earphone 616b are connected to different ground lines and thus the superposing phenomenon as described above can be avoided. However, since the number of components increases as is evident from the inductance element group 612, a new problem of an increase in the cost is caused to occur.

Therefore, to solve the problems, it is an object of the invention to provide an earphone connection cable and a portable device, etc., including the earphone connection cable for making it possible to drastically improve the sound signal transmission performance by suppressing sound signal superposing between stereo earphones or between an earphone and a microphone in a linear conductor (earphone cable) having an antenna function and a sound signal transmission function and an electronic machine, a portable device including the earphone cable, such as a mobile telephone terminal, a media player with a communication function, or a gaming machine installing a communication function.

### Means For Solving the Problems

An earphone connection cable of the invention is an earphone connection cable comprising a connector for connecting to a portable device, a reception wave transmission line, a ground line, a relay unit, at least two or more sound signal lines, and at least two or more earphones. The relay unit includes a first inductance element for connecting the antenna signal line and the ground line and second inductance elements respectively provided on the ground line and the at least two or more sound signal lines Any one of the at least two or more earphones is grounded to the reception wave transmission line and the other is grounded to the ground line.

The earphone connection cable of the invention is characterized in that the earphone connection cable further includes a second relay unit. The second relay unit includes third inductance elements respectively provided on the ground line and the at least two or more sound signal lines. Any one of the at least two or more earphones is grounded to the reception wave transmission line and the other is grounded to the ground line.

An earphone connection cable of the invention is an earphone connection cable comprising a connector for connecting to a portable device, a reception wave transmission line, a ground line, a relay unit, a sound output signal line, an earphone, a sound input signal line, and a microphone. The relay unit includes a first inductance element for connecting the antenna signal line and the ground line and second inductance elements respectively provided on the ground line, the sound output signal line, and the sound input signal line. Any one of the sound output signal line and the sound input signal line is grounded to the reception wave transmission line and the other is grounded to the ground line.

A portable device of the invention is provided with the above-described earphone connection cable.

### Advantages of the Invention

According to the earphone connection cable and the portable device including the earphone connection cable of the invention, there can be provided an earphone connection cable and a portable device for suppressing sound signal superposing between R and L earphones of stereo earphones or between an earphone and a microphone and exerting high sound signal transmission performance with a smaller number of components.

### BRIEF DESCRIPTION OF THE DRAWINGS

FIGS. 1A and 1B are configuration drawings of an earphone connection cable and a portable device to which the earphone connection cable is connected in an embodiment of the invention.

FIG. 2 is a schematic representation to describe the use state of the portable device in the embodiment of the invention.

FIGS. 3A and 3B are configuration drawings of an earphone connection cable and a portable device to which the earphone connection cable is connected in a second embodiment of the invention.

FIG. 4 is a configuration drawing of an earphone connection cable with a microphone and a portable device to which the earphone connection cable is connected in a third embodiment of the invention.

FIGS. 5A and 5B are schematic representations to describe the grounding mode of an earphone connection cable and a portable device to which the earphone connection cable is connected in a related art.

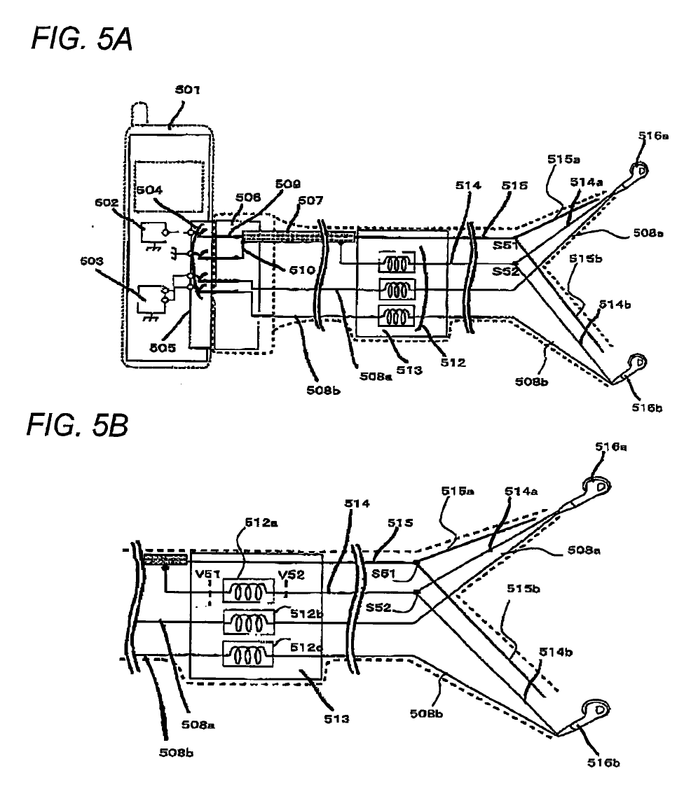

FIG. 6 is a schematic representation to describe the grounding mode of an earphone connection cable and a portable device to which the earphone connection cable is connected in a related art.

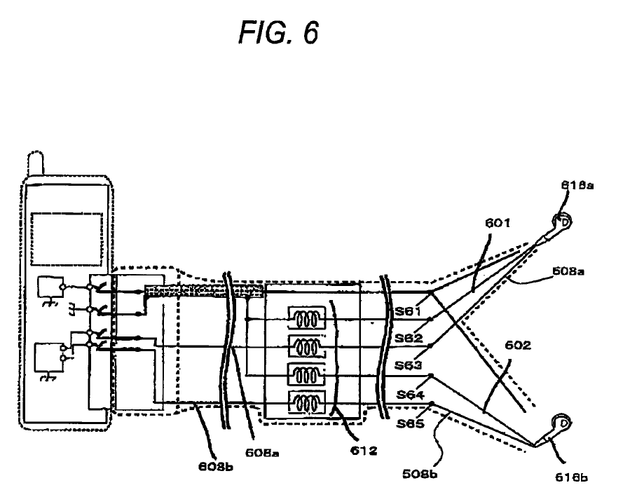

### DESCRIPTION OF REFERENCE NUMERALS

101 Portable device

102 Tuner section (reception section)

103 Sound circuit

104 Terminal spring

105 Machine connector (connection section)

106 Cable connector (connection section)

107 Coaxial line

108a R sound signal line

108b L sound signal line

109 Antenna signal line (reception wave transmission line)

110 Ground potential line

111 First inductance element

112 Second inductance element (group)

113 Relay unit (relay section)

114 Ground potential line (ground line)

115, 115a, 115b Antenna element

116a R earphone

116b L earphone

201 User (user)

301 Second relay unit (second relay section)

302 Second connection unit (second connection section)

303 Third inductance element (group)

304 Terminal spring

305 Second cable connector (connection section)

306 Second antenna element

408a Microphone input signal line

408b Earphone output signal line

405 Microphone

404 Earphone

514a R earphone ground line (R earphone ground)

514b L earphone ground line (R earphone ground)

### BEST MODE FOR CARRYING OUT THE INVENTION

An earphone connection cable and a portable device including the earphone connection cable according to each embodiment of the invention will be discussed below in detail with reference to the accompanying drawings:

### FIRST EMBODIMENT

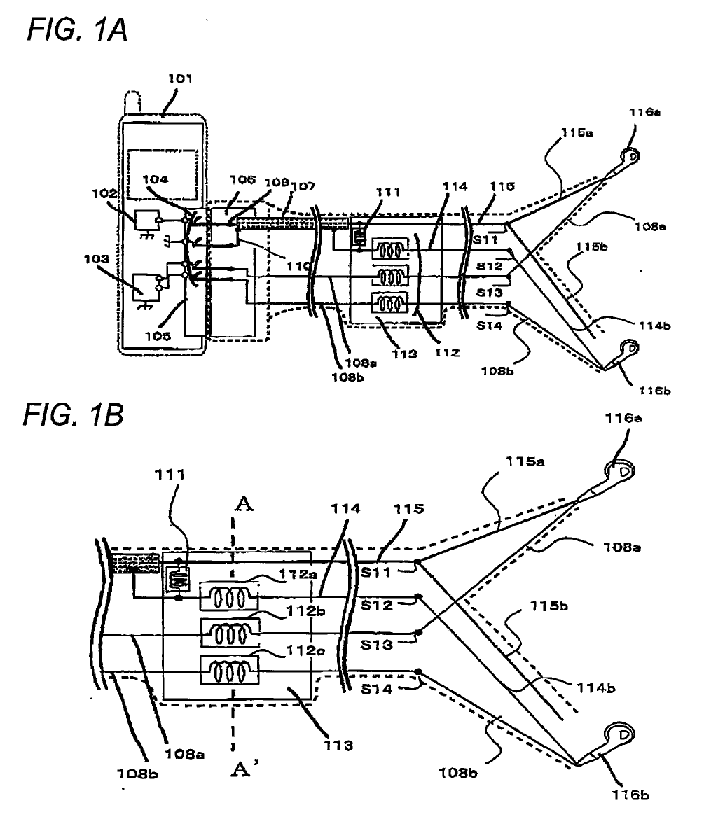

FIGS. 1A and 1B are configuration drawings of an earphone connection cable and a portable device to which the earphone connection cable is connected according to the invention. Particularly, FIG. 1A is a configuration drawing of the portable device to which the earphone connection cable is connected, and FIG. 1B is an enlarged view of the earphone connection cable portion. Members common to FIGS. 1A and 1B are denoted by the same member numbers.

A portable device 101 includes at least a tuner section 102 and a sound circuit 103 as components unique to the invention. The tuner section 102 includes a TV tuner circuit capable of receive TV broadcasts of analog terrestrial television broadcasting, digital terrestrial television broadcasting, etc., for example. The used frequency band is VHF band Low-Channel of about 90 MHz to 110 MHz, VHF band High-Channel of about 170 MHz to 220 MHz, UHF band of about 470 MHz to 770 MHz, etc., for example, for the analog terrestrial television broadcasting. It may be considered that the frequencies of the digital terrestrial television broadcasting are contained in the UHF band of about 470 MHz to 770 MHz although the band has no effect on the essence of the invention. To receive broadcasts over a plurality of frequency bands other than the TV broadcasts, the invention can be applied without changing the essential portion by taking measures of changing the antennal element length as appropriate, etc., for example.

In addition, not only a control section of a CPU, etc., and a memory device not shown, but also an input section of a keypad, etc., a display section of a liquid crystal display, etc., and the like are included as appropriate if necessary as a portable device, needless to say.

The sound circuit 103 includes a computation section and a storage section as required, performs computation processing of a sound signal, signal control, etc., and distributes the sound signal to be output to an R sound signal and an L sound signal for providing stereo output.

A cable connector 106 is connected as it is inserted into a machine connector 105 of the portable device 101 described above. A plurality of electrically conductive terminal springs 104 are disposed in the machine connector 105, and the tuner section 102, the sound circuit 103, and electronic circuitry of the control section, etc., and cable signal lines not shown in the figure are electrically connected through the terminal springs 104.

The cable signal lines are made up of an R sound signal line 108a and an L sound signal line 108b connected to the sound circuit 103, an antenna signal line 109 connected to the tuner section, and a ground potential line 110. The ground potential line 110 is grounded to ground in the portable device 101 through the terminal spring 104. The antenna signal line 109 and the ground potential line 110 are connected to a coaxial line 107 and are joined and fixed to a relay unit 113 by soldering, etc., together with the R sound signal line 108a and the L sound signal line 108b.

The coaxial line 107 is an RF high-frequency coaxial cable; for example, a cable of about 75[Ω] is used. Although the structure is not shown in the figure, generally the periphery of a bendable center conductor is coated with a low-loss foam insulator, etc., and further is covered with a netted outer conductor from the top and the outermost portion is coated with a nonconductive outer sheath. In the invention, the center conductor is connected to the antenna signal line 109 and an antenna element 115, and the outer conductor is connected to the ground potential line 110 and an inductance element 112a.

The coaxial line 107 and the plurality of signal lines described above can also be bundled as they are covered with a nonconductive material as required.

In the relay unit 113, a plurality of inductance elements 112 (112a to 112c in FIG. 1B) are disposed and the R sound signal line 108a and the L sound signal line 108b are connected via the inductance element group 112 to earphones 116a and 116b.

A flow of sound signals transmitted from the machine will be discussed in detail based on FIG. 1B. An R sound signal transmitted through the R sound signal line 108a from the machine arrives at the R earphone 116a through the inductance element 112b and a contact S13. Next, the signal turns back and is grounded to the antenna element 115 through an antenna element 115a and a contact S11. Since an antenna signal is also transmitted to the antenna elements 115 and 115a, the antenna elements 115 and 115a double as an antenna signal line and an R earphone ground line, as described later.

An L sound signal transmitted through the L sound signal line 108b from the machine arrives at the L earphone 116b through the inductance element 112c and a contact S14. Next, the signal turns back and is grounded to a ground potential line 114 through an L earphone ground line 114b and a contact S12.

Thus, the R earphone ground line and the L earphone ground line are not shared, so that the superposing phenomenon of the sound signal is suppressed.

Next, an antenna signal transmitted through the antenna signal line 109 to the tuner section of the machine arrives through the coaxial line 107 from the relay unit 113 and further propagates from antenna elements 115a and 115b branched along the R and L earphone cables with the contact S11 as a branch point through the antenna element 115.

At this time, the tip of the antenna element 115b is open (is not connected to the L earphone 116b), but the tip of the antenna element 115a is connected to the R earphone 116a. According to the configuration, the antenna element 115a also functions as an R earphone ground line.

An inductance element 111 is disposed so that it is connected to the antenna element 115 and the outer conductor of the coaxial line 107 as shown in FIGS. 1A and 1B. The inductance element 111 functions as antenna matching.

In the configuration described so far, the outer conductor of the coaxial line 107 is used as a ground line, but the embodiment is not limited to the mode; for example, the ground potential line 110 can also be connected directly to the machine side of the inductance element 112a without being connected to the outer conductor of the coaxial line 107. In this sense, the existence of the coaxial line 107 and the outer conductor thereof is only one embodiment of the invention.

The following can be said about the functional features of the inductance elements 112a to 112c: The inductances of 112a to 112c play a role in shutting off the high frequency component for the sound signal. In this sense, it can also be said that the inductances play a role of a low-pass filter or a high-pass filter. This means that when the R sound signal line 108a, the L sound signal line 108b, and the antenna element 115 placed in parallel are high-frequency capacitively coupled, leaking of a high frequency signal to the R sound signal line 108a and the L sound signal line 108b is prevented.

In the sense described above, it is desirable that the value of the inductance element to be taken (inductance value [henry]) should be selected roughly so that impedance becomes high for a signal of a frequency band of about 470 MHz to 700 MHz and becomes low for a DC component of 50 MHz or less. As is already evident, the inductance elements 112a to 112c can be replaced with an equivalent LC parallel resonance circuit, low-pass filter, etc.

Preferably, the physical placement of the inductance elements 112a to 112c is placement along the line perpendicular to the cable (perpendicular line to the cable). In FIG. 1B, they are placed so that they are aligned just in a line A-A′. It may be desirable that they should be placed with an equal spacing in some cases. Although the placement is not a direct factor contributing to higher performance of sound signal transmission that the invention aims at, since the antenna element 115 is used as the R earphone ground line, improving and maintaining of the antenna performance must also be intended and the placement of the inductance elements 112a to 112c is made more desirable from the viewpoint.

Although not an indispensable requirement as the configuration of the invention, it is desirable that the inductance element 111 and the inductance elements 112a to 112c should have the same level of DC resistance component (Ω). For example, in the embodiment, components each having about one ohm are used. Thus, the DC resistance values of the inductance element 111 and the inductance elements 112a to 112c are set to the same level, whereby good sound signal transmission performance and sound effects are provided in the experimental results.

To connect the ground potential lines of the R earphone and the L earphone, for example, the L earphone 116b may be grounded to the antenna element 115 and the R earphone 116a may be grounded to the ground line 114. This means that in the configuration of the invention, the distinction between the R earphone and the L earphone does not affect the spirit of the invention. In other words, in the earphone connection cable in FIGS. 1A and 1B, if an L sound signal is transmitted to the R sound signal line and an R sound signal is transmitted to the L sound signal line, a similar effect is provided.

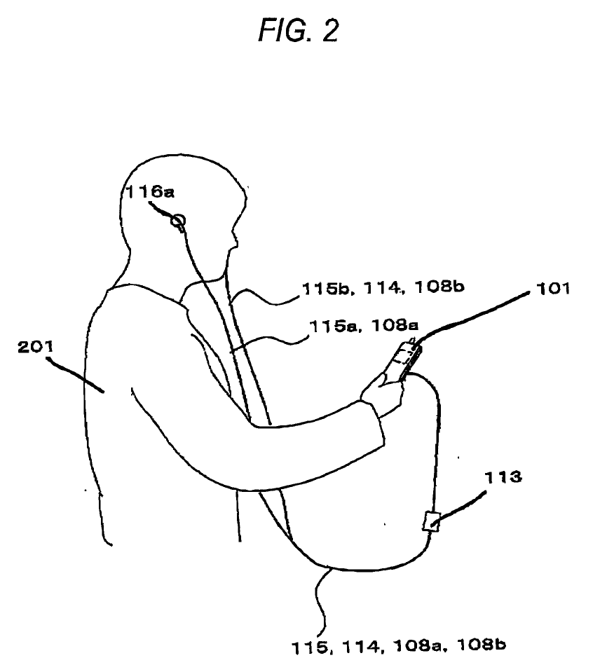

FIG. 2 is a schematic representation to describe the use state of the portable device in the embodiment of the invention.

When a user 201 uses the portable device 101 of the invention (views TV, operates, etc.,), the user places the R earphone 116a and the L earphone 116b in both ears and views TV, selects a channel, communicates, etc., with the portable device 101 held in his or her hand. At this time, the relay unit 113 is dangling in the air and the ground potential line 114, the antenna element 115, the R sound signal line 108a, and the L sound signal line 108b bundled with nonconductive cover material extend from the relay unit 113 toward the user. The bundle branches to the R earphone and the L earphone and on the R side, the antenna element 115a and the R sound signal line 108a extend toward the R earphone 116a and on the L side, the antenna element 115b, the L sound signal line 108b, and the ground potential line 114 extend toward the L earphone 116b. The relationship among and the roles of the signal lines are as previously described.

### SECOND EMBODIMENT

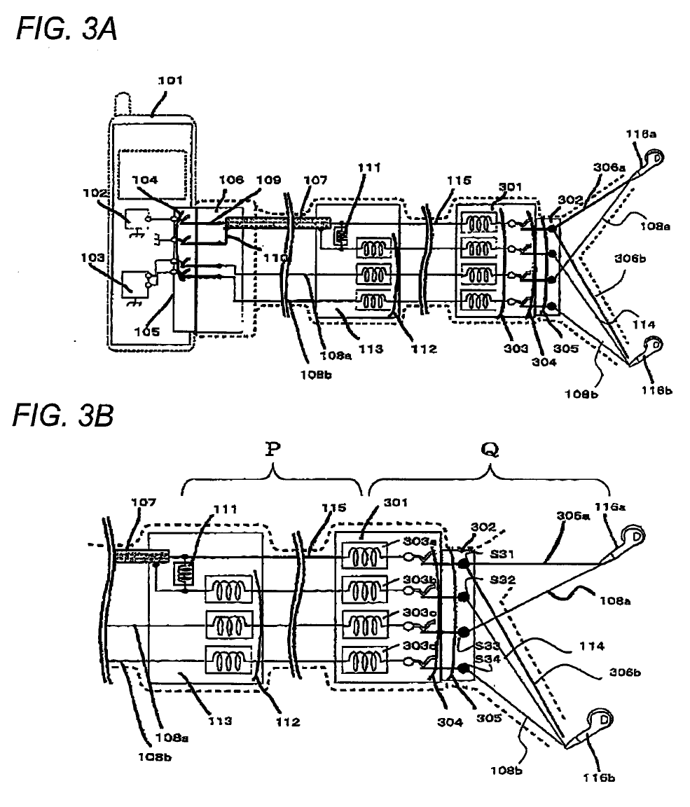

FIGS. 3A and 3B are configuration drawings of an earphone connection cable and a portable device to which the earphone connection cable is connected in a second embodiment of the invention. Particularly, FIG. 3A is a configuration drawing of the portable device to which the earphone connection cable is connected, and FIG. 3B is an enlarged view of the earphone connection cable portion. Members common to FIGS. 3A and 3B are denoted by the same member numbers. Components duplicate with those of the first embedment will not be discussed again and the point peculiar to the second embodiment will be discussed below:

A portable device in the second embodiment has a large feature that a second relay unit 301 is newly disposed between a relay unit 113 of an earphone connection cable and each earphone.

In FIG. 3A, a plurality of inductance elements 303 (corresponding to 303a to 303d in FIG. 3B) and a plurality of electrically conductive terminal springs 304 are disposed in the second relay unit 301, and a plurality of signal lines are connected to the inductance elements 303 from the machine. On the other hand, a second cable connector 305 provided in an end part of the earphone cable is connected as it is inserted into the plurality of terminal springs 304, and is also electrically connected.

A flow of electric signals in the portable device and the earphone connection cable electrically connected as described above will be discussed below based on FIG. 3B:

To begin with, an R sound signal transmitted through an R sound signal line 108a from the machine arrives at an R earphone 116a through the inductance element 303c and a contact S33. Next, the signal turns back and is grounded to a contact S31 through a second antenna element 306a.

An L sound signal transmitted through an L sound signal line 108b from the machine arrives at an L earphone 116b through the inductance element 303d and a contact S34. Next, the signal turns back and is grounded to a contact S32 through a ground potential line 114.

On the other hand, an antenna signal transmitted through an antenna signal line 109 to a tuner section of the machine arrives through a coaxial line 107, the relay unit 113, and an antenna element 115 from the second relay unit 301 and further propagates from second antenna elements 306a and 306b branched from the contact S31 through the inductance element 303a. At this time, the tip of the antenna element 306b is open (is not connected to the L earphone 116b), but the tip of the antenna element 306a is connected to the R earphone 116a. According to the configuration, the antenna element 306a also functions as an R earphone ground line.

Next, the significance of the third inductance element 303a disposed in the second relay unit 301 will be discussed. To receive TV broadcast, the inductance element 303a plays a role as an inductance element for shutting off a UHF band and allowing a VHF band to pass through. That is, the section from the portion connected to an inductance element 111 on the antenna element 115 to the portion of the inductance element 303a (P section in FIG. 3B) becomes an antenna section corresponding to UHF and further the section provided by adding the portion from the portion of the inductance element 303a through the contact S31 and the antenna element 306a to the R earphone 116a to that section (section of P+Q in FIG. 3B) becomes an antenna section corresponding to VHF.

Therefore, if it is not necessary to be compatible with both the UHF and VHF bands, etc., the third inductance element 303a can be omitted.

To connect the ground potential lines of the R earphone and the L earphone, for example, the L earphone 116b may be grounded to the antenna element 306a and the R earphone 116a may be grounded to the ground line 114. This means that in the configuration of the invention, the distinction between the R earphone and the L earphone does not affect the spirit of the invention. In other words, in the earphone connection cable in FIGS. 3A and 3B, if an L sound signal is transmitted to the R sound signal line and an R sound signal is transmitted to the L sound signal line, a similar effect is provided.

### THIRD EMBODIMENT

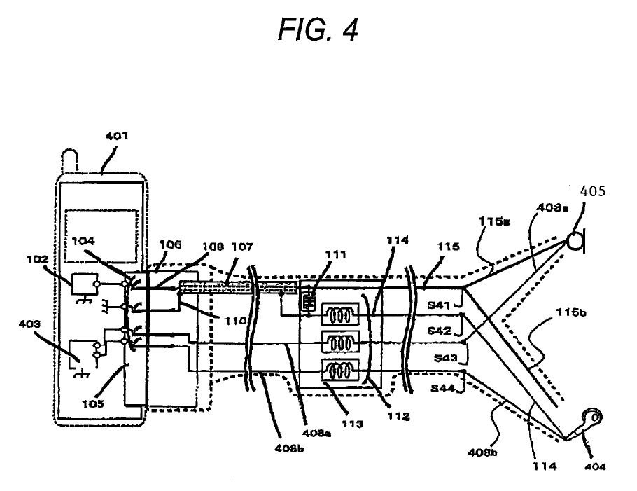

FIG. 4 is a configuration drawing of an earphone connection cable with a microphone and a portable device to which the earphone connection cable is connected in a third embodiment of the invention. Components duplicate with those of the first embedment will not be discussed again and the point peculiar to the third embodiment will be mainly discussed below:

In a portable device 401 in the third embodiment, the configuration of a sound circuit 403 is a configuration for processing a microphone input signal and an earphone output signal rather than for outputting an R sound signal and an L sound signal. On the other hand, the configuration of an earphone connection cable is not a configuration of an R earphone and an L earphone and is a configuration of a microphone input signal line 408a, a microphone 405, an earphone output signal line 408b, and an earphone 404.

In the configuration, the connection relationship will be discussed from a signal flow. To begin with, a sound signal input from the microphone 405 passes through the microphone input signal line 408a and is input to the sound circuit 403 in the portable device 401 through a contact S43 and an inductance element 112 in a relay unit 113. The microphone 405 is connected to an antenna element 115a and is grounded to a contact S41 and an antenna element 115.

Next, a sound output signal transmitted through the earphone output signal line 408b on the machine side arrives at the earphone 404 through the inductance element 112 and a contact S44 in the relay unit 113. The signal turns back and is grounded from the earphone 404 to a contact S42 through a ground potential line 114.

On the other hand, an antenna signal transmitted through an antenna signal line 109 to a tuner section 102 arrives through a coaxial line 107 from the relay unit 113 and further propagates from antenna elements 115a and 115b branched along the microphone and earphone cables with the contact S41 as a branch point through the antenna element 115 as previously described in the first embodiment.

To connect the ground potential lines of the microphone and the earphone, for example, the earphone 404 may be grounded to the antenna element 115a and the microphone 405 may be grounded to the ground line 114. This means that in the configuration of the invention, the distinction between the microphone and the earphone does not affect the spirit of the invention.

The earphone connection cable and the portable device are made detachable in each connector part, but the invention is not limited to the mode and the cable and the portable device may be provided in one piece. For example, it is also possible to house the cable in the main body of the portable device so as to wind the cable therein.

While the embodiments of the invention have been described, it is to be understood that the invention is not limited to the items disclosed in the embodiments and the invention also intends that those skilled in the art make changes, modifications, and application based on the Description and widely known arts, and the changes, the modifications, and the application are also contained in the scope to be protected.

This application is based on Japanese Patent Application (No. 2006-036312) filed on Feb. 14, 2006, which is incorporated herein by reference.

### INDUSTRIAL APPLICABILITY

As described above, the earphone connection cable and the portable device to which the earphone connection cable is connected according to the invention contribute to higher performance of sound signal transmission by suppressing sound signal superposing between stereo earphones or between an earphone and a microphone in a linear conductor (earphone cable) having an antenna function and a sound signal transmission function and an electronic machine, a portable device including the earphone cable, such as a mobile telephone terminal, a media player with a communication function, or a gaming machine installing a communication function.

1. An earphone connection cable, comprising:
a connector for connecting to a portable device;
a reception wave transmission line;
a ground line;
a relay unit;
at least two or more sound signal lines; and
at least two or more earphones,
wherein the relay unit includes:
a first inductance element which connects the reception wave transmission line and the ground line; and
second inductance elements which are respectively provided on the ground line and the at least two or more sound signal lines; and
wherein any one of the at least two or more earphones is grounded to the reception wave transmission line and the other is grounded to the ground line.

2. The earphone connection cable according to claim 1, further comprising:
a second relay unit,
wherein the second relay unit includes third inductance elements which are respectively provided on the ground line and the at least two or more sound signal lines; and
wherein any one of the at least two or more earphones is grounded to the reception wave transmission line and the other is grounded to the ground line.

3. An earphone connection cable, comprising:
a connector for connecting to a portable device;
a reception wave transmission line;
a ground line;
a relay unit;
a sound output signal line;
an earphone;
a sound input signal line; and
a microphone,
wherein the relay unit includes:
a first inductance element which connects the reception wave transmission line and the ground line; and
second inductance elements which are respectively provided on the ground line, the sound output signal line, and the sound input signal line; and
wherein any one of the sound output signal line and the sound input signal line is grounded to the reception wave transmission line and the other is grounded to the ground line.

4. A portable device provided with the earphone connection cable according to claim 1.

5. A portable device provided with the earphone connection cable according to claim 3.
